(19) United States
(12) Patent Application Publication
(10) Pub. No.: US 2023/0334578 A1
(43) Pub. Date: Oct. 19, 2023

(54) INTELLIGENT UNDERWRITING RISK MANAGEMENT METHOD, AND SYSTEM, DEVICE, MEDIUM THEREOF

(71) Applicant: BEIJING HEALINS TECHNOLOGY CO LTD, Beijing (CN)

(72) Inventors: Zhan WANG, Beijing (CN); Jianjun CAO, Beijing (CN); Zhanbin YU, Beijing (CN)

(21) Appl. No.: 17/953,998

(22) Filed: Sep. 27, 2022

(30) Foreign Application Priority Data
Apr. 18, 2022 (CN) 202210401706.3

(51) Int. Cl. G06F 40/30; G06Q 40/08; G06F 40/40; G06F 40/247

(52) U.S. Cl. CPC G06Q 40/08; G06F 40/247; G06F 40/30; G06F 40/40

(57) ABSTRACT

The invention proposes an intelligent underwriting risk management method, and system, device, medium thereof, relating the technical field of medical risk management. The procedure comprises receiving the report file to the application server through byte streams, then converting it into an image to be analyzed; preprocessing; proceeding image correction; proceeding image recognition on the corrected image by OCR technology; presetting underwriting-related thesaurus and classification annotations; proceeding semantic recognition by NLP natural semantic recognition technology to form entity features; based on the similarity algorithm, calculating according to the entity features, finding the content whose similarity reaches the preset threshold, and obtaining the medical underwriting risk content; classifying the content by manually summarizing expert experience and obtaining artificial empirical rules; classifying risk content by semantics; matching classified risk content to artificial empirical rule; generating the final underwriting conclusion table for the content that matches successfully.

### 1. TECHNICAL FIELD

The invention relates to the field of medical risk management, in particular to an intelligent underwriting risk management method, and system, device, medium thereof.

### 2. BACKGROUND ART

In the existing technology, the vast majority of the insurance underwriting industry currently adopts manual underwriting, bringing a series of limitations and pain points, which are long underwriting cycle, low efficiency and high cost. Manual underwriting requires the policyholders to provide medical records. The underwriter reviews each medical record one by one. For each case, the average review time is 10-20 minutes, and the number of cases that can be reviewed per day is only about 50 cases. However, daily pending cases can reach 200-500 per day. In case of peak business periods, theoretically, 500-1000 cases need to be reviewed every day. Manual reviews cannot be completed on time, and the long-term review manual error rate is extremely high. Moreover, there is a shortage of talents in the industry. The industry has high requirements on the qualifications and majors of underwriters, and requires compound talents with both medical and insurance expertise. The training cycle of a talent whose average underwriting authority can reach about 300,000 is more than 5 years. After the medical reform, there is a greater shortage of talents in the industry. In addition, communication links between policyholders, insurance companies, and underwriters in the traditional insurance industry are complex and difficult, resulting in the policyholders’ questions about the underwriting conclusion not being able to be answered immediately. Therefore, an intelligent underwriting risk management method and system are urgently needed.

### 3. SUMMARY OF THE INVENTION

The purpose of the invention is to provide an intelligent underwriting risk management method, in order to improve the speed of underwriting operations, shorten the review cycle, thereby relieving the operation stress of underwriting.

The embodiments of the invention are realized as follows:

First, the embodiment of the invention provides an intelligent underwriting risk management method, comprising: receive the report file to be analyzed to the application server through byte streams, then convert it into an image to be analyzed; preprocess the image to be analyzed; proceed image correction on the image to be analyzed and obtain the corrected image; proceed image recognition on the corrected image by OCR technology and obtain the recognized text; preset underwriting-related thesaurus and classification annotations; proceed semantic recognition by NLP natural semantic recognition technology to form entity features; based on the similarity algorithm, calculate according to the entity features, search for the content whose similarity reaches the preset threshold, and obtain the medical underwriting risk content; by manually summarizing the experience of experts in the field, classifying them according to the risk points of medical underwriting, and collecting relevant underwriting experience at the same time, obtain artificial empirical rules; classify risk content by semantics; match classified risk content to artificial empirical rule; generate the final underwriting conclusion table for the content that matches successfully.

In some embodiments of the invention, the artificial empirical rules also include insurance product information rules; match the medical underwriting risk points with insurance product information rules, if any insurance product in the insurance product information rule is successfully matched with the medical underwriting risk point, recommend the insurance product to the customer.

In some embodiments of the invention, the procedure of preprocessing comprises: proceed edge removal and noise removal on the image to be analyzed, convert the image to be analyzed into a grayscale image, and then proceed median filtering, and finally proceed the binarization operation to obtain the binarized image.

In some embodiments of the invention, the procedure of removing noise comprises: removing gray lines in the image to be analyzed.

In some embodiments of the invention, the procedure of proceeding image correction on the image to be analyzed and obtaining the corrected image comprises:

use the minimum circumscribed rectangle algorithm of OPENCV; preset filtering conditions, after obtaining the minimum outer rectangle containing the text and the rotation angle of the entire image, correct it to obtain the corrected image.

In some embodiments of the invention, the procedure of using the BERT model to extract the text information of the text through the recognized text [symbol] and finding the vocabularies with the highest similarity to obtain entity features comprises: preset event element templates and proceed sentence segmentation; bring the segmented vocabulary into the N-GRAM algorithm to calculate the similarity between the vocabulary and the element template, sort according to the similarity, and take the highest similarity value; proceed normalization processing to obtain entity features and standardized descriptions of the entity features.

In some embodiments of the invention, the medical report files to be analyzed include outpatient medical record files, inpatient medical record files and medical examination report files.

Second, the embodiment of the invention provides an intelligent underwriting risk management system, comprising: a data receiving module, used to receive the medical report file to be analyzed to the application server through byte streams, and then convert it into an image to be analyzed for saving; an image processing module, used for preprocessing the image to be analyzed; then proceed image correction on the image to be analyzed and obtain the corrected image; proceed image recognition on the corrected image by OCR technology and obtain the recognized text; a semantic recognition module, preset underwriting-related thesaurus and classification annotations; proceed semantic recognition by NLP natural semantic recognition technology to form entity features; based on the similarity algorithm, calculate according to the entity features, search for the content whose similarity reaches the preset threshold, and obtain the medical underwriting risk content; a rule base module, used for manually summarizing the experience of experts in the field, classifying them according to the risk points of medical underwriting, and collecting relevant underwriting experience at the same time to obtain artificial empirical rule; a risk identification module, used for classifying risk content by semantics; match classified risk content to artificial empirical rule; a result module, used for generating the final underwriting conclusion table for the content that matches successfully.

Third, the embodiment of the invention provides an electronic device, comprising at least one processor, at least one memory, and a data bus, wherein the processor and the memory communicate with each other through the data bus; the memory stores program instructions executable by the processor, and the processor invokes the program instructions to execute the method of any one of claims 1-7.

Fourth, the embodiment of the invention provides a computer-readable storage medium, on which a computer program is stored, the computer program realizes the method according to any one of claims 1-7 when executed by the processor.

Compared with the prior art, the embodiments of the invention have at least the following advantages:

Use image processing technology to extract text from unstructured files such as outpatient medical records, inpatient medical records, and physical examination reports. Then use natural semantic recognition technology for risk management, and finally conduct comparative analysis according to preset rules. Through the above methods, the speed of underwriting operations is greatly improved, the review cycle is greatly shortened, and the tremendous operating pressure can be greatly relieved.

### 4. BRIEF DESCRIPTION OF ACCOMPANY DRAWINGS

In order to illustrate the technical solutions of the embodiments of the invention more clearly, the following briefly introduces the accompanying drawings that need to be used in the embodiments. It should be understood that the following drawings illustrate only certain embodiments of the invention and are therefore not to be considered limit of scope. For those of ordinary skill in the art, other related drawings can also be obtained from these drawings without any creative effort.

FIG. 1 is a flowchart of an intelligent underwriting risk management method according to the invention;

FIG. 2 is another flowchart of an intelligent underwriting risk management method according to the invention;

FIG. 3 is a schematic diagram of an intelligent underwriting risk management system according to the invention;

FIG. 4 is a schematic diagram of an electronic device according to the invention.

Label: 1. data receiving module; 2. image processing module; 3. semantic recognition module; 4. rule base module; 5. risk recognition module; 6. result module; 7. processor; 8. memory; 9. data bus.

### 5. SPECIFIC EMBODIMENT OF THE INVENTION

In order to make the purposes, technical solutions and advantages of the embodiments of the application clearer, the technical solutions in the embodiments of the application will be clearly and completely described below with reference to the accompanying drawings in the embodiments of the application. Obviously, the described embodiments are part of, but not all embodiments of the application. The components of the embodiments of the application generally described and illustrated in the drawings herein may be arranged and designed in a variety of different configurations.

Accordingly, the following detailed description of the embodiments of the application provided in the accompanying drawings is not intended to limit the scope of the application as claimed, but is merely representative of selected embodiments of the application. Based on the embodiments in the application, all other embodiments obtained by those of ordinary skill in the art without creative work fall within the scope of protection of the application.

It should be noted that like numerals and letters refer to like items in the following drawings. Therefore, once an item is defined in one drawing, it does not require further definition and explanation in subsequent drawings. Meanwhile, in the description of this application, the terms “first”, “second”, etc. are only used to distinguish the description, and cannot be understood as indicating or implying relative importance.

It should be noted that, in the application, relational terms such as first and second are only used to distinguish one entity or operation from another entity or operation, and do not necessarily require or imply any relationship between these entities or operations. any such actual relationship or sequence exists between. Moreover, the terms “comprise”, “include” or any other variation thereof are intended to encompass non-exclusive inclusion such that a process, method, article or device comprising a list of elements includes not only those elements, but also includes not explicitly listed other elements of the process, method, article or device. Without further limitation, an element qualified by the phrase ″comprising a... ″ does not preclude the presence of additional identical elements in a process, method, article or apparatus that includes the element.

In the description of this application, it should be noted that the orientation or positional relationship indicated by the terms “upper”, “lower”, “inner”, “outer”, etc. is based on the orientation or positional relationship shown in the drawings. Or the orientation or positional relationship that the product of the application is usually placed in use is only for the convenience of describing the application and simplifying the description, rather than indicating or implying that the device or element referred to must have a specific orientation, be constructed and operation, and therefore should not be construed as a limitation on this application.

In the description of this application, it should also be noted that, unless otherwise expressly specified and limited, the terms “arrangement” and “connection” should be understood in a broad sense, for example, it can be a fixed connection, a detachable connection, or an integrated connection; it can be a mechanical connection or an electrical connection; it can be a direct connection or an indirect connection through an intermediate medium, and it can be an internal connection between two components. For those of ordinary skill in the art, the specific meanings of the above terms in this application can be understood in specific situations.

Some embodiments of the application will be described in detail below with reference to the accompanying drawings. The various embodiments described below and various features in the embodiments may be combined with each other without conflict.

### Embodiment 1

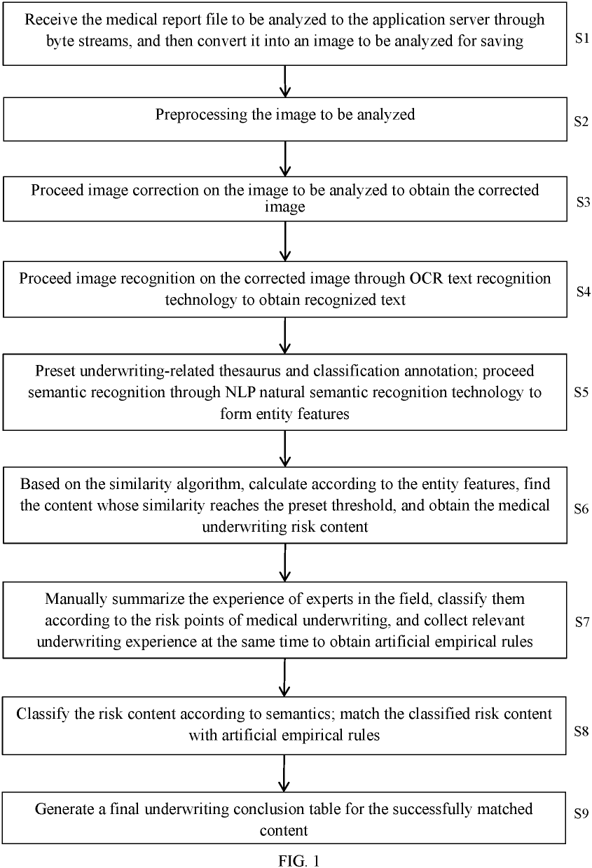

Please refer to FIG. 1, which is an intelligent underwriting risk management method provided in an embodiment of the invention. This invention adopts image processing technology to extract text from unstructured files such as outpatient medical records, inpatient medical records, and physical examination reports, then natural semantic recognition technology for risk management, and finally conducts comparative analysis according to preset rules. The above methods greatly improve the speed of underwriting operations and shorten the review cycle, which can greatly relieve the tremendous operating pressure.

S1: Receive the medical report file to be analyzed to the application server through byte streams, and then convert it into an image to be analyzed for saving;

There are many types of medical report files. Take unstructured files such as outpatient medical records, inpatient medical records, and physical examination reports as examples. Their formats are different, hence need to be converted accordingly and then saved.

S2: Preprocessing the image to be analyzed;

In order to make the image recognition effect in the subsequent steps more accurate, normal preprocessing is proceeded to facilitate subsequent accurate recognition. The procedure of preprocessing comprises: edge removal, noise removal, grayscale image conversion, filtering, and binarization operations, etc.

S3: Proceed image correction on the image to be analyzed to obtain the corrected image;

Image correction is because the shooting angle of the captured image cannot be absolutely horizontal or vertical, so correction is performed to ensure the accuracy of the recognition.

S4: Proceed image recognition on the corrected image through OCR text recognition technology to obtain recognized text;

As for underwriting content, it is generally explained in text, so OCR text recognition technology is used to obtain text information.

S5: Preset underwriting-related thesaurus and classification annotation; proceed semantic recognition through NLP natural semantic recognition technology to form entity features;

The BERT model in the NLP natural semantic recognition technology is used to perform sentence relationship judgment and natural language inference on vocabulary, which provides convenience for subsequent natural semantic recognition.

S6: Based on the similarity algorithm, calculate according to the entity features, find the content whose similarity reaches the preset threshold, and obtain the medical underwriting risk content;

After the NLP natural semantic recognition technology, the similarity calculation compares the preset vocabulary and clinical cases to provide reference content for medical underwriting risks.

S7: manually summarize the experience of experts in the field, classify them according to the risk points of medical underwriting, and collect relevant underwriting experience at the same time to obtain artificial empirical rules;

As for the content of the rules, it requires people to effectively designate. manually summarize the experience of experts in the field, and formulate it according to the relevant laws and rules.

S8: Classify the risk content according to semantics; match the classified risk content with artificial empirical rules;

The purpose of classification is to reduce the resources consumed by matching and make matching more efficient.

S9: Generate a final underwriting conclusion table for the successfully matched content. For example, customer A:

| Date | Diagnosis |
|---|---|
| 2020.12.03 | Physical examination showed left thyroid nodule, single, 1.2x1.0x0.9 cm; |
| 2021.05.05 | Outpatient visit, diagnosis of left thyroid hypoechoic nodule is to be investigated, and thyroid ultrasound report shows that the thyroid nodule is graded as TI-RADS4a; |
| 2021.12.24 | The thyroid nodule was removed in hospital, and the pathological diagnosis was “left” nodular goiter; |
| 2022.03.15 | In the outpatient thyroid ultrasound review, there was a cystic nodule on the right side of the thyroid, 0.5x0.4x0.5 cm, with a clear boundary and no blood flow signal around it; no space-occupying lesions were found in the left lobe of the thyroid. |

By presetting the underwriting-related thesaurus, classification and annotation, and semantic recognition, the following medical underwriting risk points are obtained:

| Date | Risk point content |
|---|---|
| 2020.12.03 | Disease: Thyroid Nodule; Size: 1.2x1.0x0.9 cm |
| 2021.05.05 | Disease: Thyroid nodule; Nature: Hypoechoic; Grade: TI-RADS class 4a |
| 2021.12.24 | Surgery: Thyroid nodule surgery; Pathology: Nodular goiter; Pathological nature: Benign |
| 2022.03.15 | Disease: Thyroid nodule; Nature: cystic; Size: 0.5x0.4x0.5 cm; Border: clear; Blood flow signal: not seen |

The rules of critical illness insurance in the artificial empirical rules are: 1. Critical illness insurance rule 001: Thyroid nodules not graded, with clear edges, size<1.5 cm, and insufficient blood flow, the underwriting conclusion is exclusion, excluding the insurance liability of thyroid malignant tumors (including primary, recurrent and metastatic malignant tumors and carcinoma in situ); 2. Critical illness insurance rule 002: If the thyroid nodule is diagnosed as grade 1 or 2, the underwriting conclusion is standard body; 3. Critical illness insurance rule 003: If the thyroid nodules are diagnosed as grade 3, the underwriting conclusion is exclusion, excluding the insurance liability for thyroid malignant tumors (including primary, recurrent and metastatic malignant tumors and carcinoma in situ); 4. Critical illness insurance rule 004: If the thyroid nodule is diagnosed as grade 4a, the underwriting conclusion is postponement ( postponement means that the insurance shall not be covered temporarily, and the insurance must be postponed until a certain time or after the treatment is completed); 5. Critical illness insurance rule 005: If the thyroid nodule has been operated, and the pathological diagnosis is benign, the underwriting conclusion shall be determined according to the thyroid ultrasound status of the postoperative review.

The medical insurance rules in the artificial empirical rules are: Thyroid nodules not graded, with clear edges, size<1.5 cm, and insufficient blood flow, the underwriting conclusion is exclusion, excluding the related medical expenses caused by thyroid diseases and their complications; 2. Medical insurance rule 002: For thyroid nodules of grade 3 and below, the underwriting conclusion is exclusion, excluding the related medical expenses caused by thyroid diseases and their complications; 3. Medical insurance rule 003: If the thyroid nodule has been operated, the underwriting conclusion shall be determined according to the results of the postoperative review of the thyroid ultrasound.

Match medical underwriting risk points with manual experience; obtain the following data table:

| | |
|---|---|
| Critical illness insurance underwriting conclusion | Exclusion, excluding thyroid malignancies (including primary, recurrent and metastatic malignancies and carcinoma in situ) insurance liability; |
| Medical insurance underwriting | Exclusion, excluding related medical expenses caused by thyroid disease and its complications; |

conclusion

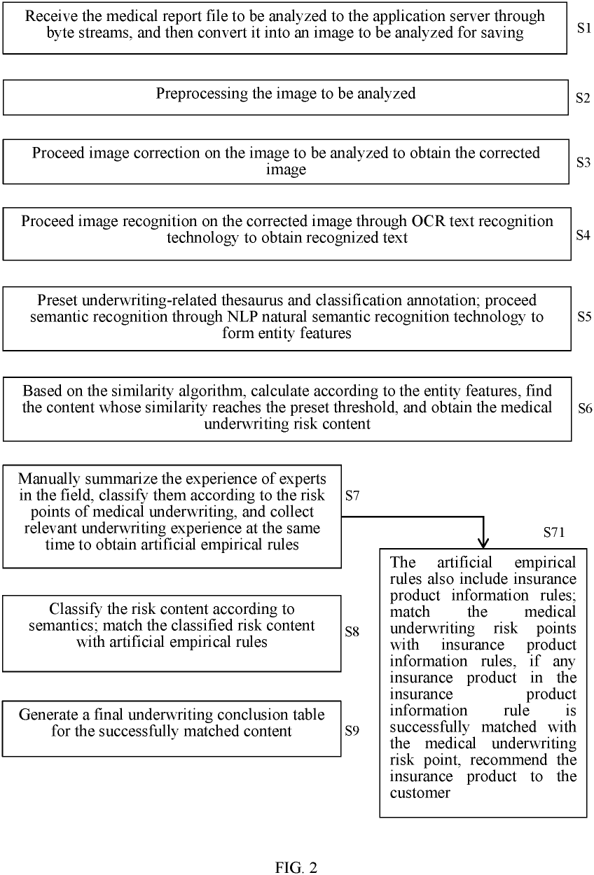

Referring to FIG. 2, in some embodiments of the invention, the steps after obtaining the final underwriting conclusion table include:

S71: the artificial empirical rules also include insurance product information rules, match the medical underwriting risk points with insurance product information rules, if any insurance product in the insurance product information rule is successfully matched with the medical underwriting risk point, recommend the insurance product to the customer.

For the insurance product categories in existing technology, specialized insurance agents are required for effective data access and information tracking of the insured, which complicates information acquisition and product recommendations. And for some customers with physical problems who tend to purchase insurance products, because the health notices of each insurance company’s insurance products differ, they need to repeatedly provide medical records and repeatedly insure, which is time-consuming and labor-intensive, and the experience is terrible. Therefore, the recommendation of insurance products on the basis of the underwriting conclusion improves efficiency.

Here customer A is still taken as an example for the recommendation of insurance products:

The information rules of insurance product A in manual experience are: 1. The thyroid nodule has been surgically treated more than 3 months ago, the pathological result is benign, and there is no abnormality in the thyroid ultrasound review in the past six months, the underwriting conclusion is standard body; 2. When the thyroid nodule meets the following conditions: (1) the maximum diameter of the nodule does not exceed 1.5 cm; (2) the border is smooth or clear; (3) there is no blood flow signal, the underwriting conclusion is exclusion, excluding very early malignant tumors or malignant lesions of the thyroid, malignant tumors and their metastasis and recurrence.

The information rules of insurance product A in manual experience are: 1. The thyroid nodule has been surgically treated more than 6 months ago, the pathological result is benign, and there is no abnormality in the thyroid ultrasound review within the past half year, the underwriting conclusion is standard body; 2. Thyroid nodules meet the following conditions: (1) the maximum diameter of the nodule does not exceed 2 cm; (2) the border is smooth or clear; (3) there is no blood flow signal, the underwriting conclusion is exclusion, the company will not be responsible for the payment of insurance benefits for the insured’s treatment due to thyroid nodules and their complications.

Customer A has had thyroid surgery for more than 3 months but less than 6 months, and the pathology is benign. The maximum diameter of the thyroid nodule is less than 1 cm in the postoperative re-examination, the boundary is clear, and there is no blood flow signal. The above information rules of insurance product A are successfully matched with the medical underwriting risk points, and insurance product A can be recommended. The underwriting conclusion for Customer A to purchase this product is exclusion, excluding very early malignant tumors or malignant lesions of the thyroid, malignant tumors and their metastasis and recurrence.

In some embodiments of the invention, the procedure of preprocessing comprises:

Proceed edge removal and noise removal on the image to be analyzed, convert the image to be analyzed into a grayscale image, and then proceed median filtering, and finally proceed the binarization operation to obtain the binarized image.

The specific implementation for preprocessing is as follows. Perform operations such as edge removal, noise removal (two gray lines), filtering, binarization, etc., mainly refers to changing the edge of the image to white, removing the gray line, and converting the image to grayscale mode. Perform median filtering, binarize and finally save the image, the processed image becomes a black image with a white bottom.

In some embodiments of the invention, the procedure of removing noise comprises: removing gray lines in the image to be analyzed.

In some embodiments of the invention, the procedure of correcting the image to be analyzed and then obtaining the corrected image comprises: use the minimum circumscribed rectangle algorithm of OPENCV; preset filtering conditions, after obtaining the minimum outer rectangle containing the text and the rotation angle of the entire image, correct it to obtain the corrected image.

The specific implementation is to use the minimum circumscribed rectangle method of OPENCV (ie, the MINAREARECT( ) function) to operate. This method will return the left side of the center point of the smallest bounding rectangle, the width, height, and rotation angle of the rectangle, specifically: First, use MINAREARECT( ) to obtain the minimum circumscribed rectangle in the image, and add certain filtering conditions (such as the area of the rectangle is greater than 100, the rotation angle is less than 45 degrees, etc.) to obtain the minimum outer rectangle containing the text, and its rotation angle is the entire image angle of rotation.

In some embodiments of the invention, the procedure of using the BERT model to extract the text information of the text by recognizing the text and find the vocabularies with the highest similarity to obtain entity features comprises: preset event element templates and proceed sentence segmentation, bring the segmented vocabulary into the N-GRAM algorithm to calculate the similarity between the vocabulary and the element template, sort according to the similarity and take the highest similarity value, proceed normalization processing to obtain entity features and standardized descriptions of the entity features.

The specific implementation is: Specify event element templates, segment sentences, and use N-GRAM on vocabularies; query the similarity between each N-GRAM and the templates, sort the N-GRAM according to the similarity, take the N-GRAM wi; th the highest similarity, and finally form the formatted content of “entity-feature”; through the normalization method, the standardized description of the features is realized.

In some embodiments of the invention, the medical report files to be analyzed include outpatient medical record files, inpatient medical record files, and physical examination report files.

### Embodiment 2

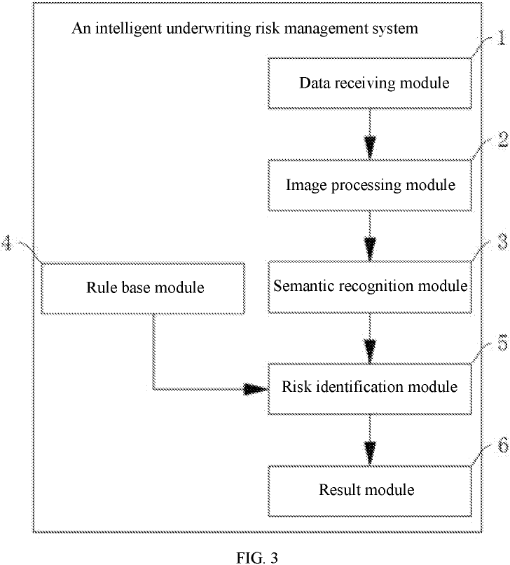

Referring to FIG. 3, the invention provides an intelligent underwriting risk management system, comprising: a data receiving module 1, receiving the medical report file to be analyzed to the application server through byte streams, and then converting it into an image to be analyzed for saving; an image processing module 2, preprocessing the image to be analyzed; proceeding image correction on the image to be analyzed and obtaining the corrected image; proceeding image recognition on the corrected image by OCR technology and obtaining the recognized text; a semantic recognition module 3, presetting underwriting-related thesaurus and classification annotations; proceeding semantic recognition by NLP natural semantic recognition technology to form entity features; based on the similarity algorithm, calculating according to the entity features, searching for the content whose similarity reaches the preset threshold, and obtaining the medical underwriting risk content; a rule base module 4, by manually summarizing the experience of experts in the field, classifying them according to the risk points of medical underwriting, and collecting relevant underwriting experience at the same time, obtaining artificial empirical rules; a risk identification module 5, classifying risk content by semantics; matching classified risk content to artificial empirical rules; a result module 6, generating the final underwriting conclusion table for the content that matches successfully.

### Embodiment 3

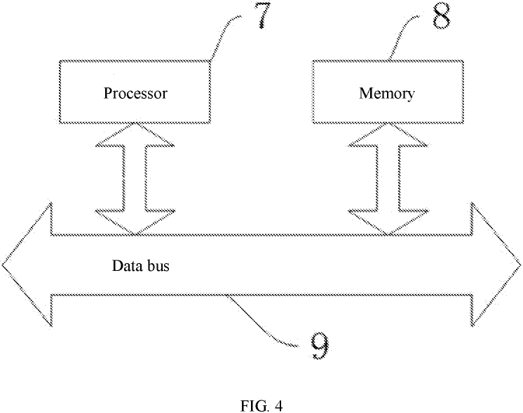

Please refer to FIG. 4, which is an electronic device provided by the invention, comprising at least one processor 7, at least one memory 8 and a data bus 9; wherein the processor 7 and the memory 8 communicate with each other through the data bus 9; the memory 8 stores program instructions executable by the processor 7, and the processor 7 invokes the program instructions to execute an intelligent underwriting risk management method. For example, to implement:

Receive the report file to be analyzed to the application server through byte streams, then convert it into an image to be analyzed; preprocess the image to be analyzed; proceed image correction on the image to be analyzed and obtain the corrected image; proceed image recognition on the corrected image by OCR technology and obtain the recognized text; preset underwriting-related thesaurus and classification annotations; proceed semantic recognition by NLP natural semantic recognition technology to form entity features; based on the similarity algorithm, calculate according to the entity features, search for the content whose similarity reaches the preset threshold, and obtain the medical underwriting risk content; by manually summarizing the experience of experts in the field, classifying them according to the risk points of medical underwriting, and collecting relevant underwriting experience at the same time, obtain artificial empirical rule; classify risk content by semantics; match classified risk content to artificial empirical rule; generate the final underwriting conclusion table for the content that matches successfully.

### Embodiment 4

The invention provides a computer-readable storage medium on which a computer program is stored. When the computer program is executed by the processor 7, an intelligent underwriting risk management method is implemented. For example, to implement:

Receive the report file to be analyzed to the application server through byte streams, then convert it into an image to be analyzed; preprocess the image to be analyzed; proceed image correction on the image to be analyzed and obtain the corrected image; proceed image recognition on the corrected image by OCR technology and obtain the recognized text; preset underwriting-related thesaurus and classification annotations; proceed semantic recognition by NLP natural semantic recognition technology to form entity features; based on the similarity algorithm, calculate according to the entity features, search for the content whose similarity reaches the preset threshold, and obtain the medical underwriting risk content; by manually summarizing the experience of experts in the field, classifying them according to the risk points of medical underwriting, and collecting relevant underwriting experience at the same time, obtain artificial empirical rule; classify risk content by semantics; match classified risk content to artificial empirical rule; generate the final underwriting conclusion table for the content that matches successfully.

Wherein, the memory 8 can be, but not limited to Random Access Memory (RAM), Read-Only Memory (ROM), Programmable Read-Only memory (PROM), Erasable Programmable Read-Only Memory (EPROM), Electrically Erasable Programmable Read-Only Memory (EEPROM), and so on.

The processor 7 can be an integrated circuit chip with signal processing capability. The processor 7 can be a general-purpose processor, including Central Processing Unit (CPU), Network Processor (NP), etc.; it can also be a Digital Signal Processor (DSP), an Application-Specific Integrated Circuit (ASIC), a Field-Programmable gate array (FPGA) or other programmable logic devices, discrete gate or transistor logic devices, discrete hardware components.

The above descriptions are only preferred embodiments of the application, and are not intended to limit the application. For those skilled in the art, various modifications and variations of this application can be made. Any modification, equivalent replacement, improvement, etc. made within the spirit and principle of this application shall be included within the protection scope of this application.

For those skilled in the art, it is obvious that the application is not limited to the details of the above-mentioned exemplary embodiments, and that the application can be implemented in other specific forms without departing from the spirit or essential characteristics of the application. Accordingly, the embodiments should be considered in all respects to be exemplary and non-restrictive. The scope of the application is defined by the appended claims rather than the above description, and therefore all changes that come within the meaning and range of equivalency of the claims are intended to be embraced within this application. Any reference signs in the claims shall not be construed as limiting the involved claim.

1. An intelligent underwriting risk management method comprises:
Receive the report file to be analyzed to the application server through byte streams, then convert it into an image to be analyzed;
preprocess the image to be analyzed;
proceed image correction on the image to be analyzed and obtain the corrected image;
proceed image recognition on the corrected image by OCR technology and obtain the recognized text;
preset underwriting-related thesaurus and classification annotations; proceed semantic recognition by NLP natural semantic recognition technology to form entity features;
based on the similarity algorithm, calculate according to the entity features, search for the content whose similarity reaches the preset threshold, and obtain the medical underwriting risk content;
by manually summarizing the experience of experts in the field, classifying them according to the risk points of medical underwriting, and collecting relevant underwriting experience at the same time, obtain the artificial empirical rules;
classify risk content by semantics, match classified risk content to artificial empirical rule;
generate the final underwriting conclusion table for the content that matches successfully.

2. The intelligent underwriting risk management method of claim 1, the artificial empirical rules also include insurance product information rules; match the medical underwriting risk points with insurance product information rules, if any insurance product in the insurance product information rule is successfully matched with the medical underwriting risk point, recommend the insurance product to the customer.

3. The intelligent underwriting risk management method of claim 1, the procedure of preprocessing comprises:
proceed edge removal and noise removal on the image to be analyzed, convert the image to be analyzed into a grayscale image, and then proceed median filtering, and finally proceed the binarization operation to obtain the binarized image.

4. The intelligent underwriting risk management method of claim 3, the procedure of removing noise comprises: removing gray lines in the image to be analyzed.

5. The intelligent underwriting risk management method of claim 1, the procedure of proceeding image correction on the image to be analyzed and obtaining the corrected image comprises:
use the minimum circumscribed rectangle algorithm of OPENCV, preset filtering conditions, after obtaining the minimum outer rectangle containing the text and the rotation angle of the entire image, correct it to obtain the corrected image.

6. The intelligent underwriting risk management method of claim 1, the procedure of using the BERT model to extract the text information of the text through the recognized text and finding the vocabularies with the highest similarity to obtain entity features comprises:
preset event element templates and proceed sentence segmentation, bring the segmented vocabularies into the N-GRAM algorithm to calculate the similarity between the vocabulary and the element template, sort according to the similarity and take the highest similarity value, proceed normalization processing to obtain entity features and standardized descriptions of the entity features.

7. The intelligent underwriting risk management method of claim 1, the medical report files to be analyzed include outpatient medical record files, inpatient medical record files and medical examination report files.

8. An intelligent underwriting risk management system comprises:
a data receiving module, used to receive the medical report file to be analyzed to the application server through byte streams, and then convert it into an image to be analyzed for saving;
an image processing module, used for preprocessing the image to be analyzed; then proceed image correction on the image to be analyzed and obtain the corrected image; proceed image recognition on the corrected image by OCR technology and obtain the recognized text;
a semantic recognition module, preset underwriting-related thesaurus and classification annotations; proceed semantic recognition by NLP natural semantic recognition technology to form entity features; based on the similarity algorithm, calculate according to the entity features, search for the content whose similarity reaches the preset threshold, and obtain the medical underwriting risk content;
a rule base module, used for manually summarizing the experience of experts in the field, classifying them according to the risk points of medical underwriting, and collecting relevant underwriting experience at the same time to obtain artificial empirical rule;
a risk identification module, used for classifying risk content by semantics; match classified risk content to artificial empirical rule;
a result module, used for generating the final underwriting conclusion table for the content that matches successfully.

9. An electronic device, comprises at least one processor, at least one memory, and a data bus, wherein the processor and the memory communicate with each other through the data bus; the memory stores program instructions executable by the processor, and the processor invokes the program instructions to execute the method recited in claim 1.

10. A computer-readable storage medium on which a computer program is stored, wherein the computer program realizes the method recited in claim 1 when executed by the processor.
